(19) United States
(12) Patent Application Publication
(10) Pub. No.: US 2022/0201803 A1
(43) Pub. Date: Jun. 23, 2022

(54) THIN FILM HEATER AND METHOD OF MAKING

(71) Applicant: Thinnovations, LLC, Columbus, OH (US)

(72) Inventor: James Andrew DICKSON, Columbus, OH (US)

(21) Appl. No.: 17/555,142

(22) Filed: Dec. 17, 2021

Related U.S. Application Data
(60) Provisional application No. 63/126,606, filed on Dec. 17, 2020.

(51) Int. Cl. H05B 3/20; H05B 3/14; C09D 5/24; C09D 5/00; C09D 7/40; C09D 7/20; C09D 163/00

(52) U.S. Cl. CPC H05B 3/20; H05B 3/145; C09D 5/24; C09D 5/002; C09D 7/70; C09D 7/20; C08K 3/041; H05B 2214/04; H05B 2203/017; H05B 2203/016; H05B 2203/019; C08K 2201/001; C09D 163/00

(57) ABSTRACT

A thin film heater is provided containing conductive nanofiller particles and a base material, wherein the conductive nanofiller particles are uniformly distributed within the base material and is soluble in water. When introduced to electric current, the thin film heater raises in temperature and lowers in resistance. A method of manufacturing a thin film heater is also provided, including the steps of mixing the conductive nanofiller particles with water to form a precursor, mixing the precursor with a base material, and applying the mixture to a substrate. Once the thin film heater cures on the substrate, the thin film heater will resistively heat the substrate when introduced to electric current.

### TECHNICAL FIELD

Provided is an electrically conductive coating composition, and more particularly, a conductive coating composition which may be applied to a substrate surface to form a film which is resistively heatable.

### BACKGROUND

Electronics have become so integrated into society, that it is routine for a person to use electronics for even the most mundane aspects of life. This integration of technology into everyday objects has made conductive materials deliverable in a flexible medium desirous. One such material is conductive paint, which combines conductive particles and a liquid medium, thus creating an electrically conductive paint. Oftentimes, these conductive particles are in the form of metals such as copper or silver, however, such metals can add significant weight to the paint due to their higher density levels. Additionally, such paints may also be subject to corrosion.

Nanofillers, such as nanoparticles or particulates, are an alternative to typical metal fillers and offer high-aspect ratio, light weight, high mechanical strength, high electrical and thermal conductivity, and unique optoelectronic properties. Non-limiting examples of such nanofiller particles are CNTs (Carbon Nanotube), Nano Graphene Platelets (NGP), nanohorns, and Nanoclays (NC). However, due to their high polarizability and strong van der Waals interactions between one another, nanofiller particles can be difficult to process and manipulate in a host matrix, proving it difficult to realize the potential of these materials. Additionally, their poor solubility in organic solvents and aqueous solutions is a considerable challenge for their manipulation, separation and assembly, which, are key factors in many applications.

Accordingly, there is a need in the art for a conductive material that takes advantage of the properties of nanofiller particles, while being easy to process and manipulate and soluble. The disclosure herein meets those needs by providing an electrically conductive coating composition, or thin film heater, including CNTs that is soluble and easily manipulated. This thin film heater can be applied to a variety of surfaces and substrates, and can function as a resistive heating element.

### SUMMARY

In embodiments of the invention, a thin film heater mixture is provided including conductive nanotubes uniformly dispersed within an aqueous base material. In another embodiment, a thin film heater is provided including conductive nanotubes uniformly dispersed within a base material, and at least two conductive leads connected to a power source and embedded within the uniform dispersion of conductive nanotubes and base material. In another embodiment, a method of making a thin film heater is provided including uniformly mixing nanoparticles with solvent to create a precursor, uniformly mixing the precursor with a base material to form a mixture, applying the mixture to a substrate, embedding at least two conductive leads connected to a power source within the mixture, and curing the mixture on the substrate.

These and other embodiments can each optionally include one or more of the following features.

In some embodiments of the invention, the amount of conductive nanotubes reach a percolation threshold. In some embodiments of the invention, the conductive nanotubes are multi-walled carbon nanotubes. In some embodiments of the invention, the aqueous base material includes water.

In some embodiments of the invention, the amount of conductive nanotubes is between 0-32.1% w/w and the amount of aqueous base material is between 67.9-100% w/w. In some embodiments of the invention, the uniformly dispersed conductive nanotubes and base material are stable for at least 15 months. In some embodiments of the invention, the resistance of the conductive nanotubes uniformly dispersed within the base material is between 0-300 Ohm-cm.

In some embodiments of the invention, the conductive nanotubes raise the temperature of the base material when introduced to electric current. In some embodiments of the invention, the resistance of the conductive nanotubes uniformly dispersed within the base material decreases as the temperature of the conductive nanotubes uniformly dispersed within the base material increases.

In some embodiments of the invention, the conductive nanotubes uniformly dispersed within the base material are applied to a substrate. In some embodiments of the invention, the thin film heater further includes at least an event sensor that is capable of sensing the change in physical properties of the substrate, and transmitting a signal to the power source to increase or decrease electric current to the conductive leads. In some embodiments of the invention, the thin film heater further includes a primer coating on the substrate, wherein the conductive nanotubes uniformly dispersed within the base material overlays the primer coating.

In embodiments of the invention, a method of making a thin film heater. The method includes uniformly mixing nanoparticles with solvent to create a precursor. The method further includes uniformly mixing the precursor with a base material to form a mixture. The method further includes applying the mixture to a substrate. The method further includes embedding at least two conductive leads connected to a power source within the mixture. The method further includes curing the mixture on the substrate.

In some embodiments of the invention, the nanoparticles are multi-walled carbon nanotubes. In some embodiments of the invention, the solvent is water. In some embodiments of the invention, the base material comprises a polymer, a plasticizer, and a curing agent. In some embodiments of the invention, the mixture is applied to a primer coating on the substrate.

The above summary may present a simplified overview of some embodiments of the invention in order to provide a basic understanding of certain aspects of the embodiments of the invention discussed herein. The summary is not intended to provide an extensive overview of the embodiments of the invention, nor is it intended to identify any key or critical elements, or delineate the scope of the embodiments of the invention. The sole purpose of the summary is merely to present some concepts in a simplified form as an introduction to the detailed description presented below.

### BRIEF DESCRIPTION OF THE DRAWINGS

FIG. 1 is a magnified illustration of an exemplary embodiment of a thin film heater.

FIG. 2 is an illustration of a cross-sectional view of an exemplary embodiment of a thin film heater applied to a substrate.

FIG. 3 is a graph of the change in temperature versus electricity in an exemplary embodiment of a thin film heater.

FIG. 4 is an illustration of a cross-sectional view of an exemplary embodiment of a thin film heater applied to a primer coating applied to a substrate.

FIG. 5 is an illustration of a cross-sectional view of an exemplary embodiment of a top coating applied to a thin film heater applied to a primer coating applied to a substrate.

FIG. 6 is a flowchart illustrating a method of manufacturing an exemplary thin film heater.

FIG. 7 is a flowchart illustrating another method of manufacturing an exemplary thin film heater.

FIG. 8 is a photo depicting the thermal distribution of an exemplary embodiment of thin film heater when resistively heating.

FIG. 9 is a magnified photo of an exemplary embodiment of a thin film heater taken by a scanning electron microscope.

FIG. 10 is a magnified photo of an exemplary embodiment of a thin film heater taken by a scanning electron microscope.

### DETAILED DESCRIPTION

For thin film heaters, film resistance is the result of various factors. One factor is the nanofiller particles themselves. Many inherent factors of the nanoparticles or particulates influence the electronic properties of nanofiller particles, including surface area or aspect ratio of the nanotube, diameter, chirality, defect, curvature, and local environment. Additionally, high polarizability and strong van der Waal interactions can create a heterogeneous, or uneven, distribution of the nanofiller particles, which in turn may lower the conductivity of the film.

Another factor is, in the case of nanotubes, the existence of barriers at inter-tube junctions. Conductivity occurs through electron transport via the hopping mechanism at inter-tube junctions, and the distance of the inter-tube junctions, can lower or prevent conductivity. When the distance of the inter-tube junctions is close enough to allow electron transport and therefore conductivity, the thin film heater has met the percolation threshold. Percolation is a statistical geometric theory that has established the universality of the exponents in the power law dependence of geometrical parameters. In plain terms, for thin film heaters containing nanotubes just above the percolation threshold, film resistance reduces dramatically with the increase in film thickness, while in the region far from the threshold, film resistance decreases inversely with film thickness, as expected for constant conductivity.

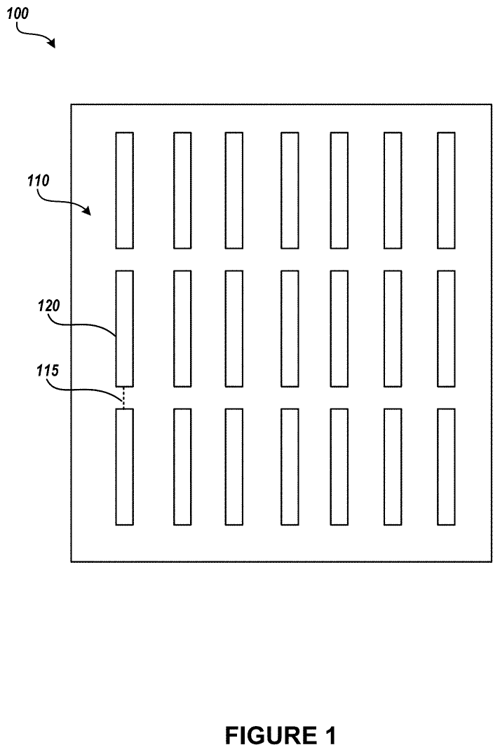

FIG. 1 is in an exemplary embodiment of a thin film heater 100. The thin film heater 100 is made up of a base material 120 and conductive nanofiller particles 110 evenly distributed therein. When the base material is close enough, the inter-tube junctions 115 may allow electron transport and therefore conductivity. The base material 120 may be a resin material (including but not limited to a one-part resin; a two-part resin; a one-component resin; and a two-component resin, optionally, with a catalyst and/or hardener), an epoxy material, a ceramic material, or a urethane material (including but not limited to 373P23290™ Flexible Weatherable Primer by Axalta). The base material 120 may exhibit moisture resistance, ultraviolet light resistance, acid resistance, and/or base resistance. Any or all of these properties may result in a thin film heater 100 with low permeability, low surface energy, high durability, and high flexibility.

The conductive nanofiller particles 110 may be electrically conductive nanotubes (single-walled, double-walled, multi-walled, or mixtures thereof), nanographene, nanographene ribbons, NGPs, carbon nanomaterials (nanotubes, nanoribbons, etc.), nanohorns, and/or NCs. In one embodiment, the amount of conductive nanofiller particles 110 is at least enough to reach the percolation threshold, or between 0-5.1% w/w (including 0.1%, 1%, 4%, and 5%, or 0.1-5.1%, 1-5.1%, or 4-5.1%), 0-9.1% w/w (including 0.1%, 1%, 4%, 5%, and 9%, or 0.1-9.1%, 1-9.1%, 4-9.1%, or 5-9.1%), 0-32.1% w/w (including 0.1%, 1%, 4%, 5%, and 32%, or 0.1-32.1%, 1-32.1%, 4-32.1%, 5-32.1%, 32-32.1%), by weight of the thin film heater.

The conductive nanofiller particles 110 are evenly distributed within the base material 120, forming a uniform solid dispersion. A solid dispersion is a system where particles of one material are dispersed in a solid phase of another material. Here, conductive nanofiller particles 110 are dispersed within the solid (cured) base material 120. The distribution of nanofiller particles 110 are not inhomogeneous, but instead uniform and unvaried or substantially unvaried. Substantially unvaried means limited to no clumping (agglomeration) of large groups (e.g., a group of 10+) of nanofiller particles 110.

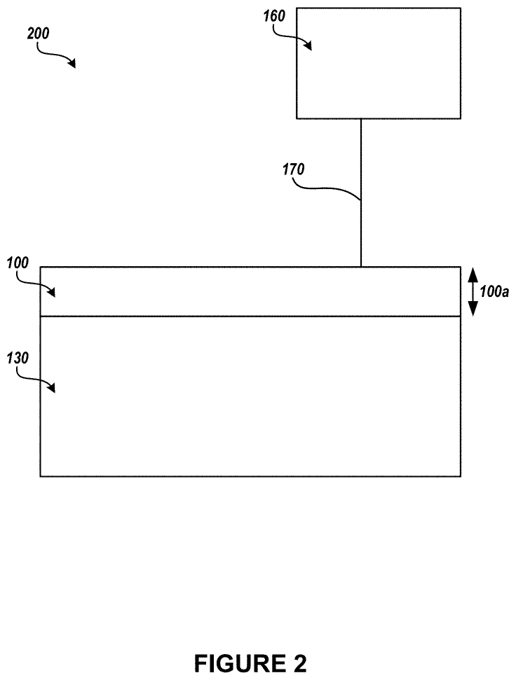

FIG. 2 illustrates another exemplary embodiment of a thin film heater apparatus 200 that includes thin film heater 100 applied to a substrate 130. As the thin film heater 100 is heated by an electric current (AC or DC), heat is transferred from the thin film heater 100 to the substrate 130. In this embodiment, the resistance of the thin film heater 100 may be between 0-300 Ohm-cm, more preferably between 0-50 Ohm-cm, and most preferably between 0-10 Ohm-cm. In one embodiment, the resistance of the thin film heater is 0.5 Ohm-cm. The electric current may be supplied from a controllable power source 160. In one implementation, the power source supplies 1-480 volts (V). For example, the power source can be a 3.6 V battery, a 12 V battery, a 24 V battery, or 110V AC up to 480V AC

Electric current may be applied to the thin film heater 100. In one embodiment, the thin film heater 100 may resistively heat uniformly across the surface area of the thin film heater 100. In another embodiment, the thin film heater 100 may include at least two conductive leads 170 connected to the controllable power source 160 and embedded within the thin film heater 100 for applying a current to the film. Any suitable conductive leads 170 may be used. In a non-limiting example, copper strip electrical contacts may be used.

In another embodiment, the substrate 130 may be connected to at least one event sensor, which is capable of sensing an event related to the substrate 130 and transmits a signal to the source of electric current. The source of electric current may then cause electric current to flow to the thin film heater 100, causing the thin film heater 100 to heat up, which in turn heats the substrate 130. For example, the event sensor may sense a change in temperature, the formation of ice, etc. Upon sensing an event such as the formation of ice on the substrate 130, the event sensor may transmit a signal to the power source, which in turn increases the electric current to the thin film heater 100, causing the thin film heater 100 to emit heat which is then transferred to the substrate 130, which results in the deicing of the substrate 130.

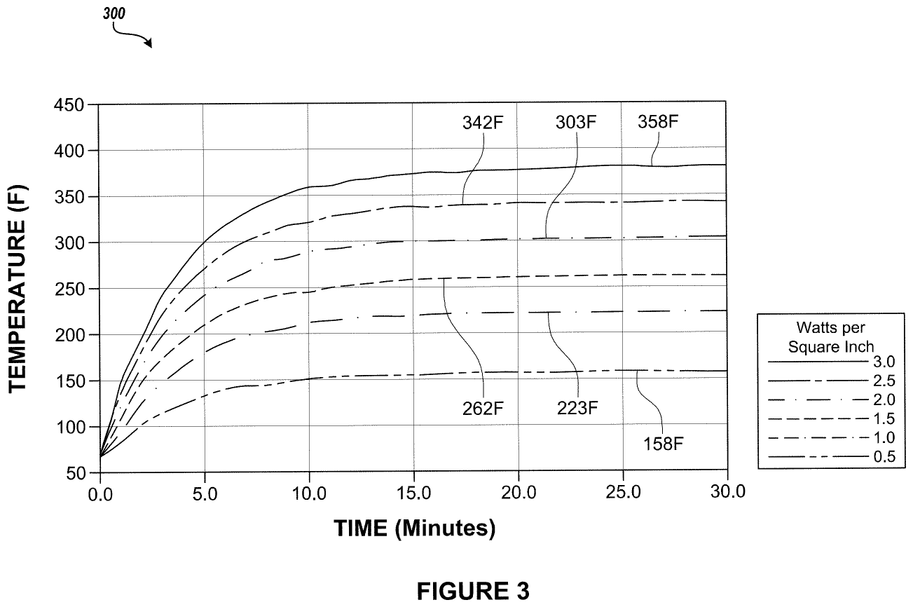

FIG. 3 is a graphic representation 300 of the amount of electric current introduced to the thin film heater 100, versus the temperature of the thin film heater 100. In one embodiment, the application of electric current to the thin film heater 100 causes the thin film heater 100 to heat to a temperature between about (±3) 20° C. and about (±3) 400° C. As the thin film heater 100 raises in temperature, the base material 120 will retain the mechanical performance of the material's matrix, while enhancing the conductive, thermal, static-dissipative, and EMI-shielding properties.

In another embodiment, the thin film heater 100 may be configured to meet, but not exceed a desired temperature threshold. In this embodiment, the distance between the inter-tube junctions 115 and the thickness of the thin film heater 100a may cause the resistance to be low enough or high enough to keep the thin film heater 100 at, and not above, a desired temperature. The thickness of the thin film heater when dry may be between 0.001-1 inches (in.) thick, more preferably 0.003-0.005 in. thick. In another embodiment, the thin film heater 100 may be configured to have a negative temperature coefficient of resistance (TCR), causing the resistance of the thin film heater 100 to decrease as the temperature increases, thus increasing efficiency.

In another embodiment, the thin film heater 100 may be inherently a strain gauge, or gauge of damage. Here, by monitoring the resistance of the thin film heater 100, damage to the substrate 130 (e.g., deforming, scratching, cutting, bending, etc.) can be determined. For example, if the blades of a wind turbine (the substrate) were coated with the thin film heater 100, the increase or decrease of the resistance of the thin film heater 100 could indicate damage to the blades.

The substrate 130 may be selected from glass, natural fabric, synthetic fabric, metals, elastomer, wood, plastics, composites (e.g., aluminum composites, carbon fiber composites, and the like), polymers, thermoplastics, thermosets, ceramics, or combinations thereof. In one embodiment, the substrate 130 may be high density polyethylene (HDPE). For example, the substrate 130 may be components of automobile mirrors, vehicle window defrosters, refrigerator windows, outdoor panel displays, and other heating systems. In these examples, when introduced to electric current, the thin film heater 100 may melt ice on the substrate 130. In another example, the substrate 130 may be an oil pipeline or storage tanks for oil. Here, when introduced to electric current, the thin film heater 100 may remediate paraffin wax, remediate or prevent hydrate formation or hydrate build-up, and/or control viscosity of the oil.

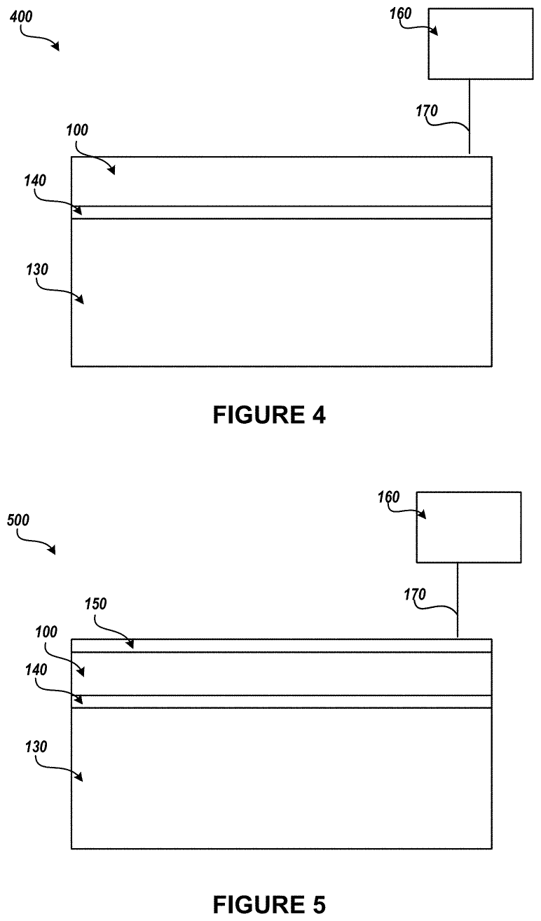

FIG. 4 illustrates an exemplary embodiment of a thin film heater apparatus 400 that includes thin film heater 100 applied to a substrate 130 via a primer coating 140. In an exemplary embodiment, the substrate 130 may include a primer coating 140, where the thin film heater 100 overlies the primer coating 140. The primer coating 140 may enhance bonding between the thin film heater 100 and substrate 130, prevent corrosion of the substrate 130, and/or prevent thermal damage to the substrate 130 in the form of a thermal barrier. Additionally, the primer coating 140 may exhibit dielectric properties to prevent the conduction of electrical current to the substrate 130. The primer coating 140 may be, for example, an epoxy-based or polyurethane-based material. Additionally, the primer coating 140 may contain additives such as corrosion inhibitors. One such non-limiting example of a corrosion inhibitor is CrO₄²⁻ (chromate).

FIG. 5 illustrates an exemplary embodiment of a thin film heater apparatus 500 that includes thin film heater 100 applied to a substrate 130 via a primer coating 140 and a top coating 150. In an exemplary embodiment, a top coating 150 may overlay the thin film heater 100. The top coating 150 may be selected from a polyurethane, epoxy, polycarbonate, siloxane, or combinations thereof. Additionally, the top coating 150 may contain additives, such as a thermally conductive filler, making the top coating thermally conductive. In one embodiment, the top coating 150 may have the same composition as the primer coating 140.

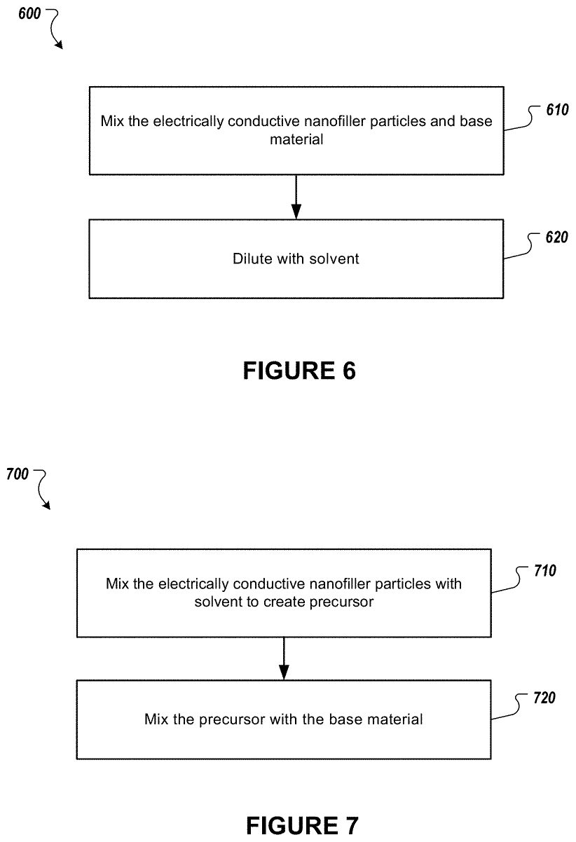

FIG. 6 illustrates an exemplary embodiment of a method 600 of manufacturing a thin film heater (e.g., thin film heater 100 of FIG. 1). The electrically conductive nanofiller particles and base material are mixed at 610. For example, base material 120 and the conductive nanofiller particles 110 may be mixed by a paddle mixer, a Banbury mixer, a Haake mixer, a homogenizer, a sonication mixing device, or the like. Then the nanofiller particles and base material are diluted with a solvent at 620. In another embodiment, the nanofiller particles and base material may be mixed using sonication.

FIG. 7 illustrates an exemplary embodiment of a method 700 of manufacturing a thin film heater (e.g., thin film heater 100 of FIG. 1). The electrically conductive nanofiller particles is mixed with a solvent to create a precursor material at 710. For example, the nanofiller particles may be selected from electrically conductive nanotubes (single-walled, double-walled, multi-walled, or mixtures thereof), nanographene, nanographene ribbons, NGPs, carbon nanomaterials (nanotubes, nanoribbons, etc.), nanohorns, and/or NCs.

The precursor created at 710 is mixed with the base material at 720. For example, the precursor may be mixed with the base material 120 by a mixer, such as a paddle mixer, a Banbury mixer, a Haake mixer, a homogenizer, a sonication device, or the like. The base material may be anything suitable such as a resin material (including but not limited to a one-part resin; a two-part resin; a one-component resin; and a two-component resin, optionally, with a catalyst and/or hardener), an epoxy material, a ceramic material, a urethane material, or the like.

The nanofiller particles may be modified/functionalized, or unmodified/unfunctionalized. The solvent may be selected from water, acetone, methyl ethyl ketone (MEK), xylene, etc. In an embodiment, the solvent may be a low viscosity carrier. In one embodiment, the nanofiller particles may be multi-walled carbon nanotubes (without a functional group, such as a carboxylic group), and the solvent is distilled water. In another embodiment, the precursor material may contain 0.1% to about (±2%) 45% w/w of nanofiller particles, more preferably about (±2%) 10% to about (±2%) 40% w/w of the nanofiller particles, most preferably about (±2%) 15% to about (±2%) 35% w/w of nanofiller particles, and about (±2%) 55% to 99.9% w/w of the solvent. In one embodiment, the precursor material contains from about (±0.2%) 0.5% to about 3% (±0.2%) w/w of the nanofiller particles, and about (±0.2%) 97% to about (±0.2%) 99.5% w/w of the solvent.

In one embodiment, in a homogenizer, about (±10%) half of the nanofiller particles may be added to the full amount of solvent. Once uniformly mixed, the remaining nanofiller particles may be added to the homogenizer. After the nanofiller particles are uniformly mixed with the solvent, the precursor may be formed. The precursor's mixture of nanofiller particles and solvent is a uniform liquid dispersion. A liquid dispersion is a system where particles of one material are dispersed in a liquid phase of another material. Here, conductive nanofiller particles are dispersed within the aqueous solvent. The distribution of nanofiller particles is not inhomogeneous, but instead uniform and unvaried or substantially unvaried. Substantially unvaried means limited to no clumping (agglomeration) of large groups (e.g., a group of 10+) of nanofiller particles.

In one embodiment, the precursor has a viscosity of about (±10) 300 to about (±10) 700 cP. In another embodiment, the precursor may be thickened by further mixing the mixture.

Additionally, or alternatively, in some implementations, additives may be added at 720 when the precursor is mixed with the base material. For example, the additive may be a plasticizer, a curing agent, or a combination thereof. The addition of a plasticizer may increase the flexibility and/or durability of the thin film heater. In one embodiment, the wet thin film heater mixture contains about (±5%) 19% to about (±5%) 30% w/w base material, about (±0.2%) 0.5% to about (±0.2%) 3% w/w nanofiller particles, about (±5%) 60% to about (±5%) 80% w/w solvent. In another embodiment, the wet thin film heater mixture contains about (±5%) 16% to about (±5%) 30% w/w base material, about (±0.2%) 0.5% to about (±0.2%) 3% w/w nanofiller particles, about (±5%) 60% to about (±5%) 80% w/w solvent, and about (±0.2%) 3% to about (±0.2%) 5% w/w plasticizer.

In some implementations, the mixture of precursor, base material, and additives is a uniform liquid dispersion. Here, conductive nanofiller particles are dispersed within the aqueous solvent, base material, and any additives. The distribution of nanofiller particles are not inhomogeneous, but instead uniform and unvaried or substantially unvaried. Substantially unvaried means limited to no clumping (agglomeration) of large groups (e.g., a group of 10+) of nanofiller particles.

In one embodiment, the base material composition is a non-conducting or substantially non-conducting polymer. Non-limiting examples of non-conducting polymer that can be used in accordance with the methods described herein include: polyepoxides, polyethylene terephthalate (PET), high-density polyethylene (HDPE), low-density polyethylene (LDPE), ultra-high-molecular-weight polyethylene (UHMWPE), polycarbonate, polystyrene, acrylic, poly(methyl methacrylate) (PMMA), poly(2-hydroxyethyl methacrylate) (PHEMA), polyacrylamide, polyacrylic acid, thermoset polyurethane, thermoplastic polyurethane, polyurethane foam, polytetrafluoroethylene (PTFE), ePTFE (GORE-TEX), polydimethylsiloxane (PDMS), poly(lactic-co-glycolic acid) (PLGA), poly-L-lactide (PLLA), polyglycolic acid (PGA), polyether ether ketone (PEEK), isoprene, polyvinyl chloride (PVC), polyether block amide (PEBAX), silicone, polyaldehyde, polypropylene, nylon, polyester, polyamide, polyimide, polybutadiene, nitrile butadiene rubber (NBR), synthetic rubber, block copolymers, sulfonated block copolymers, sulfonated perfluorinated polymers, styrene-isoprene-butadiene-styrene (SIBS), polymer electrolyte membranes (PEM), polyurea, and combinations thereof. In addition, one or more prepolymers and/or monomers of the above can be used, along with suitable polymerization and/or curing agents.

In another embodiment, the base material composition may be an epoxy resin combined with a curing agent. In one embodiment, the curing agent may be selected from polyfunctional amines, anhydrides, acids, phenols, alcohols, and thiols.

In another embodiment, the base material composition may include two resins, an aliphatic polyisocyanate and a saturated polyester. Fluorinated polyurethane may be added to impart characteristics such as low surface energy and chemical resistance for corrosive environments. This resin system (polyisocyanate, polyester, fluorinated polyurethane) may be cured using an optional dibutyl tin catalyst additive.

In another embodiment, the nanofiller particles may be multi-walled carbon nanotubes approximately 10 nm in diameter and with lengths ranging between 1 and 10 microns to achieve an electrical conductivity that enabled resistive heating of the coating. In another embodiment, the plasticizer may be epoxidized soybean oil. In another embodiment, the thin film heater may contain the following components by weight percent: 37% polyisocyanate, 50% polyester, 10% fluorinated polyurethane, 0.4% dibutyl tin catalyst, and 4% SMW grade multi-walled nanotubes.

After mixing all components, the thin film heater may be stable for a range of time. Here, stable means that after storing the wet thin film heater mixture for a set period of time, when it is applied to the substrate and dries, it exhibits the same mechanical and physical properties that are exhibited when the thin film heater is manufactured and applied on the same day. In one embodiment, when stored in an airtight container at about (±5° C.) 25° C., the thin film heater may be stable for at least 15 months.

In another exemplary embodiment, a method of applying a thin film heater is presented. The thin film heater may be applied by techniques including, but not limited to, spraying, dipping, spreading, pouring, bonding, troweling, application with a brush or roller, electrostatic coating, and fusion bonding. In multi-component coatings, the described components may be mixed together and then the mixture is applied; or to apply one, two, or more components separately in sequence or simultaneously, e.g., spraying different components with separate sprayers or spraying different components with a dual, triple, or more component feed system so that the mixture is sprayed from one exit port or nozzle.

Once applied to the substrate, at least two conductive leads connected to a controllable power source may be embedded within the wet thin film heater. The thin film heater may then cure and harden on the surface of the substrate. When electricity is introduced to the thin film heater through the conductive leads, the thin film heater may resistively heat uniformly across the surface area of the thin film heater.

### Example 1

A) To create the Precursor Material:

1. Pour 3,785 mL of distilled water into a glass or stainless steel cylindrical container.

2. Add about half of the multi-walled nanotubes into the container containing the distilled water.

3. Add a homogenizer to the container and immerse it into the distilled water and multi-walled nanotubes. Turn on the homogenizer at its lowest speed (around 1,000 RPM) and gradually increase the speed to about 8,000-10,000 RPM for 1 minute.

4. Turn off the homogenizer and add the remaining multi-walled nanotubes.

5. Resume mixing at a medium power setting (15,000-16,000 RPM) for 15 minutes.

6. After roughly 15 minutes, the liquid should start to thicken.

7. After confirming that the liquid is thickening, continue mixing for 30-45 more minutes. The suspension should be noticeably thick at this point.

B) To create the Sprayable Coating:

1. Add Water Based Epoxy Part A and a plasticizer using a paddle mixer.

2. When ready to apply, mix Water Based Epoxy Epoxy Part B at a 0.91:1 ratio and apply to the substrate.

### Example 3

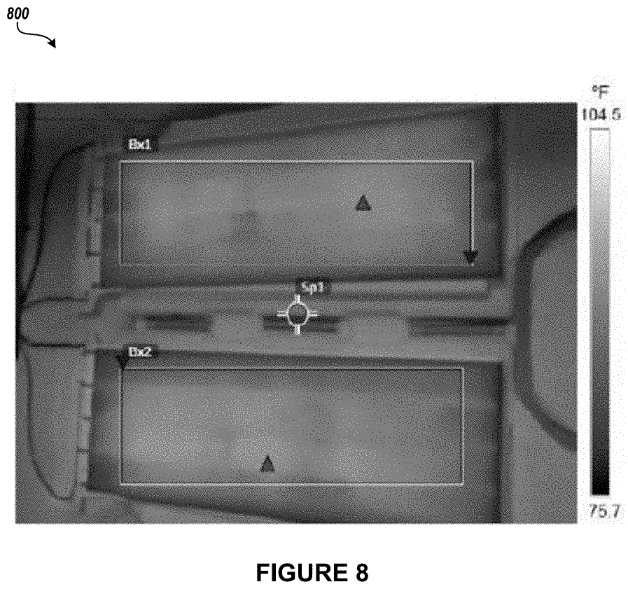

FIG. 8 is a photo 800 depicting the thermal distribution of an exemplary embodiment of thin film heater when resistively heating. For example, photo 800 illustrates a sample thin film heater as described herein was thermally imaged while resistively heating. The thin film heater was observed to evenly distribute heat across the surface area of the thin film heater.

### Example 4

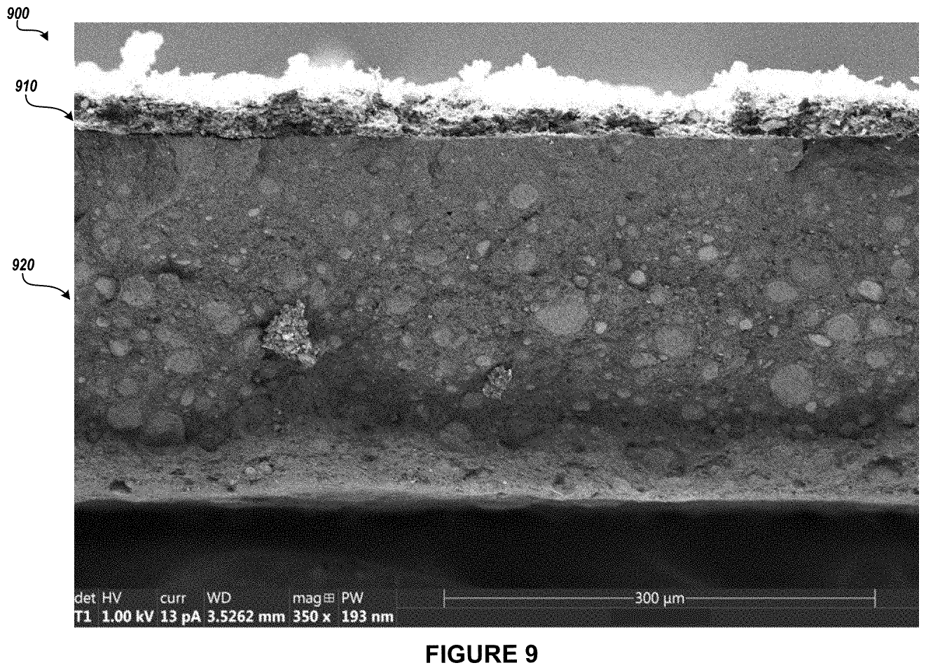

FIG. 9 is a magnified photo 900 of an exemplary embodiment of a cross-section of a thin film heater taken by a scanning electron microscope. For example, photo 900 illustrates a sample thin film heater applied to a substrate as described herein as imaged by a scanning electron microscope. In particular, at the current magnification of photo 900, a coating 910 and a substrate 920 of the thin film heater was observed.

### Example 5

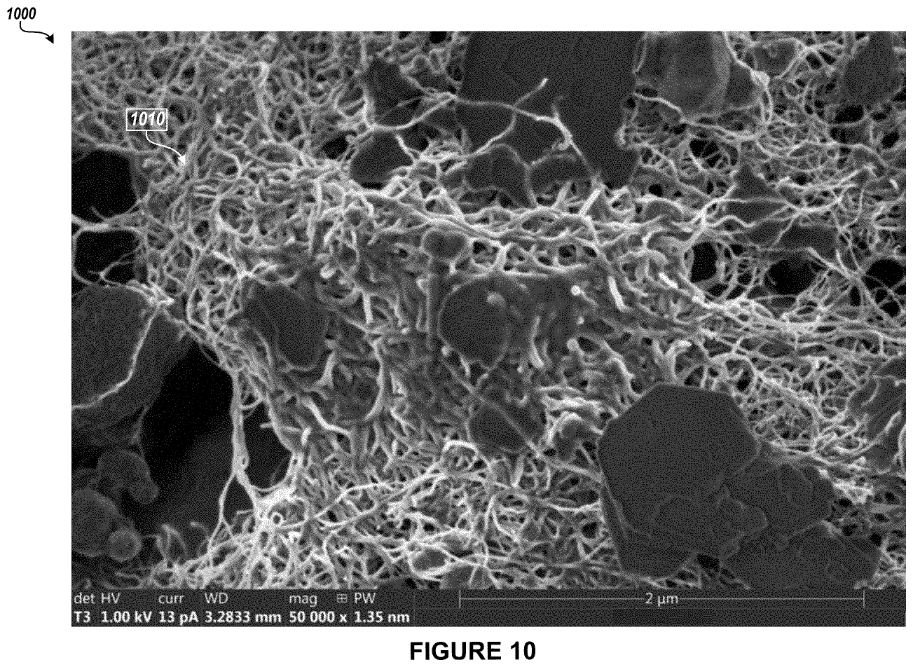

FIG. 10 is a magnified photo 1000 of an exemplary embodiment of a thin film heater taken by a scanning electron microscope. For example, photo 1000 illustrates a sample thin film heater as described herein as imaged by a scanning electron microscope. In particular, at the current magnification of photo 1000, the multi-walled nanotubes 1010 were observed.

### Example 6

When stored in an airtight container at about (±5° C.) 25° C., the thin film heater was observed to be stable at 15 months from the initial date of storage.

What is claimed is:

1. A thin film heater mixture comprising:
conductive nanotubes uniformly dispersed within an aqueous base material.

2. The thin film heater mixture of claim 1, wherein the amount of conductive nanotubes reach a percolation threshold.

3. The thin film heater mixture of claim 2, wherein the conductive nanotubes are multi-walled carbon nanotubes.

4. The thin film heater mixture of claim 1, wherein the aqueous base material includes water.

5. The thin film heater mixture of claim 1, wherein the amount of conductive nanotubes is between 0-32.1% w/w and the amount of aqueous base material is between 67.9-100% w/w.

6. The thin film heater mixture of claim 1, wherein the uniformly dispersed conductive nanotubes and base material are stable for at least 15 months.

7. A thin film heater comprising:
conductive nanotubes uniformly dispersed within a base material; and
at least two conductive leads connected to a power source and embedded within the uniformly dispersion of conductive nanotubes and base material.

8. The thin film heater of claim 7, wherein the conductive nanotubes are multi-walled carbon nanotubes.

9. The thin film heater of claim 7, wherein the amount of conductive nanotubes is between 0-32.1% w/w and the amount of base material is between 67.9-100% w/w.

10. The thin film heater of claim 7, wherein the resistance of the conductive nanotubes uniformly dispersed within the base material is between 0-300 Ohm-cm.

11. The thin film heater of claim 7, wherein the conductive nanotubes raise the temperature of the base material when introduced to electric current.

12. The thin film heater of claim 11, wherein the resistance of the conductive nanotubes uniformly dispersed within the base material decreases as the temperature of the conductive nanotubes uniformly dispersed within the base material increases.

13. The thin film heater of claim 7, wherein the conductive nanotubes uniformly dispersed within the base material are applied to a substrate.

14. The thin film heater of claim 13, further comprising at least an event sensor that is capable of sensing the change in physical properties of the substrate, and transmitting a signal to the power source to increase or decrease electric current to the conductive leads.

15. The thin film heater of claim 13, further comprising a primer coating on the substrate, wherein the conductive nanotubes uniformly dispersed within the base material overlays the primer coating.

16. A method of making a thin film heater comprising:
uniformly mixing nanoparticles with solvent to create a precursor;
uniformly mixing the precursor with a base material to form a mixture;
applying the mixture to a substrate;
embedding at least two conductive leads connected to a power source within the mixture; and
curing the mixture on the substrate.

17. The method of claim 16, wherein the nanoparticles are multi-walled carbon nanotubes.

18. The method of claim 16, wherein the solvent is water.

19. The method of claim 16, wherein the base material comprises a polymer, a plasticizer, and a curing agent.

20. The method of claim 16, wherein the mixture is applied to a primer coating on the substrate.
